(19) United States
(12) Patent Application Publication
(10) Pub. No.: US 2026/0157898 A1
(43) Pub. Date: Jun. 11, 2026

(54) WHEELCHAIR-INTEGRATED EXOSKELETON ASSEMBLY

(71) Applicant: IVAN ENRIQUE OLIVOS CACERES, HOLLYWOOD, FL (US)

(72) Inventor: IVAN ENRIQUE OLIVOS CACERES, HOLLYWOOD, FL (US)

(21) Appl. No.: 18/974,097

(22) Filed: Dec. 9, 2024

(51) Int. Cl. A61G 5/14; B25J 9/00

(52) U.S. Cl. CPC A61G 5/14; B25J 9/0006

(57) ABSTRACT

A wheelchair-integrated exoskeleton assembly is disclosed for the rehabilitation of individuals with limited mobility of the lower extremities. The assembly combines a wheelchair with a lightweight ergonomic exoskeleton designed for seamless integration and stability across various configurations. The wheelchair features two main larger wheels, two smaller front wheels, two smaller rotating back wheels, and lateral wheelchair plates defining its contours. The exoskeleton comprises a dorso-lumbar support assembly and articulated extremity assemblies. The dorso-lumbar support assembly integrates a support plate, a perpendicular plate, and a fork plate for ergonomic functionality. Articulated pedaling and lifting rods enhance the mobility and adaptability of the exoskeleton. The system ensures the user's position at the wheelchair's center of gravity, maintaining stability in both static seated and dynamic bipedal configurations. This innovative assembly facilitates enhanced rehabilitation by combining the benefits of wheelchair mobility and lower extremity exoskeleton functionality.

### CROSS-REFERENCE

This invention is related to Chilean patent application number A/P/2024/3407, filed on Nov. 7, 2024, by Ivan Enrique Olivos Caceres.

### BACKGROUND

The present invention is directed to a wheelchair-integrated exoskeleton assembly for the rehabilitation of individuals with limited mobility of the lower extremities.

Currently, many wheelchairs are designed to transport individuals with limited mobility from one location to another. There are also bipedal or stand-up wheelchairs that aim to transition the user from a seated position to a standing position, alleviating several problems associated with prolonged sitting in users with reduced mobility. However, the primary drawback of these two types of wheelchairs is that they do not allow the user to perform the motor function of moving their lower extremities, relegating such functionality solely to exoskeletons or robotic devices.

Another issue is that bipedal or stand-up wheelchairs often fail to fully elevate the user into an upright position due to instability caused by shifting the user's center of gravity away from the wheelchair. Additionally, these existing methods do not accommodate the integration of an exoskeleton, as most are heavy and bulky due to the hydraulic, pneumatic, or electromechanical systems embedded in their joints to provide motorized movement.

This highlights the need for a wheelchair capable of fully elevating an individual with limited mobility to a fully upright position without displacing the user's center of gravity, while also allowing for the incorporation of a lightweight and slim exoskeleton that requires a minimal number of hydraulic, pneumatic, or electromechanical mechanisms.

The proposed device consists of a wheelchair that does not exceed the general dimensions of a standard wheelchair and that is constructed with two pairs of plates shaped like the sides of a standard wheelchair that support the wheels, and lateral stability rods that connect the two pairs of lateral plates to a lower central pair of plates positioned parallel to the two pairs of lateral plates. This design creates an open space in the middle of the wheelchair for the integration of a lower extremity exoskeleton. The exoskeleton attaches to the wheelchair through two rod assemblies inserted between each pair of lateral plates. One rod assembly serves as the mechanical lifting element, while the other provides the mechanical actuation for the extremities. These mechanical elements, located on the lateral plates, connect to the exoskeleton at two points: one at the hip level and the other at the heel level.

The solution proposed in this application is a wheelchair that integrates an articulated exoskeleton with a movable dorso-lumbar support. The support is adjustable for both seated and standing positions, facilitating the rehabilitation of individuals with limited lower extremity mobility.

In this context, the integration of this device enables individuals with reduced mobility to transition from a seated to a standing position as quickly as humanly possible, while also allowing for movement of their lower extremities. This functionality mimics the natural human gait in an automated manner, giving the sensation of levitation within the space where the wheelchair efficiently integrates the exoskeleton.

This innovation is critical to developing a new concept of wheelchair-integrated exoskeletons designed for the rehabilitation of individuals with reduced mobility.

The advantages of the device include enhanced stability, as the exoskeleton positions the user at the wheelchair's center of gravity and does not shift its own center of gravity when changing configurations, ensuring perfect balance while the user is standing. This design enables effective lower extremity motor movement.

Moreover, the device can be used outside clinical environments and wherever necessary, as it does not exceed the general dimensions of a standard wheelchair.

### SUMMARY

The present invention relates to a wheelchair-integrated exoskeleton assembly designed for the rehabilitation of individuals with limited mobility of the lower extremities. The invention combines the structural advantages of a wheelchair with the functionality of an ergonomic exoskeleton to provide stability and facilitate rehabilitation through both static and dynamic configurations.

The assembly comprises a wheelchair that does not exceed the general dimensions of a standard wheelchair and that is equipped with two main larger wheels, two smaller front wheels, and two smaller rotating back wheels. The wheelchair features a first and second pair of parallel lateral wheelchair plates on opposite sides, which define its lateral contours. A lightweight ergonomic exoskeleton perpendicularly inserts between these lateral plates and includes a dorso-lumbar support assembly and two articulated extremity assemblies, each with upper femoral and lower distal ends connected by articulations.

A transverse rod connects the dorso-lumbar support assembly and the upper femoral ends of the extremity assemblies to lifting rod assemblies that are rotationally attached to the lateral wheelchair plates. The lower distal ends of the extremity assemblies are connected to pedaling rod assemblies that are also rotationally attached to the lateral wheelchair plates. This configuration allows for coordinated movements and seamless integration of the exoskeleton into the wheelchair.

The assembly may also comprise stability rods to brace the wheelchair plates for increase stability and structural integrity. It may further comprise footrests with adjustable fastening straps for user comfort and adaptability, as well as rotatable back wheels and horizontally attached armrests with push handles for enhanced maneuverability and user convenience.

The exoskeleton positions the user at the wheelchair's center of gravity, ensuring stability across all configurations, from static seated use to dynamic bipedal movement.

The object of the invention is to provide a lightweight wheelchair-integrated exoskeleton assembly that enhances the rehabilitation process for individuals with limited lower extremity mobility by offering a stable, ergonomic, and versatile system capable of transitioning seamlessly between seated and bipedal configurations.

### BRIEF DESCRIPTION OF THE DRAWINGS

These and other features, aspects, and advantages of the present invention will become better understood with regards to the following description, appended claims, and drawings where:

FIG. 1 is an exploded front isometric view of the wheelchair-integrated exoskeleton assembly;

FIG. 2 is an exploded back isometric view of the wheelchair-integrated exoskeleton assembly;

FIG. 3 is an exploded front isometric view of the wheelchair;

FIG. 4 is an exploded front isometric view of the dorso-lumbar support assembly;

FIG. 5 is an exploded front isometric view of the lightweight ergonomic exoskeleton for the lower extremities; and

FIG. 6 is a front view of the lifting rod assembly and the pedaling rod assembly.

### DESCRIPTION

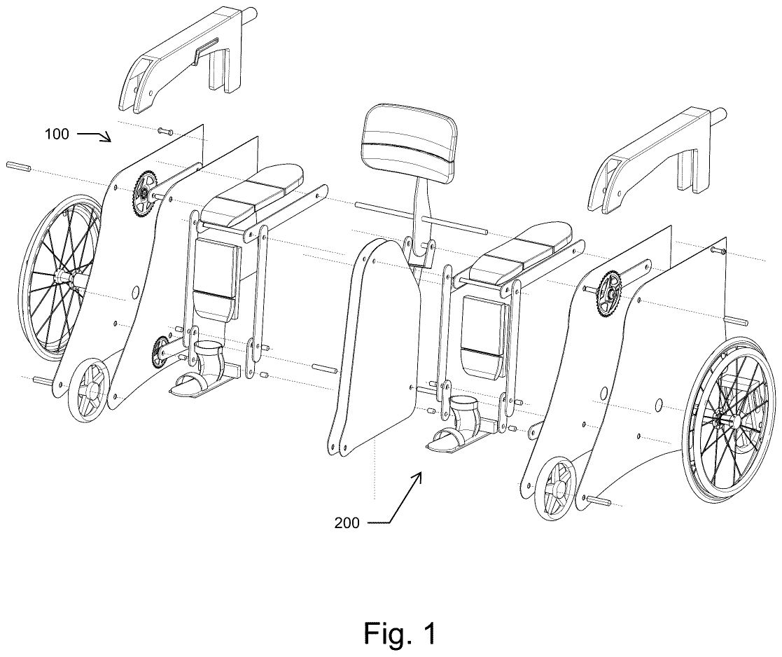

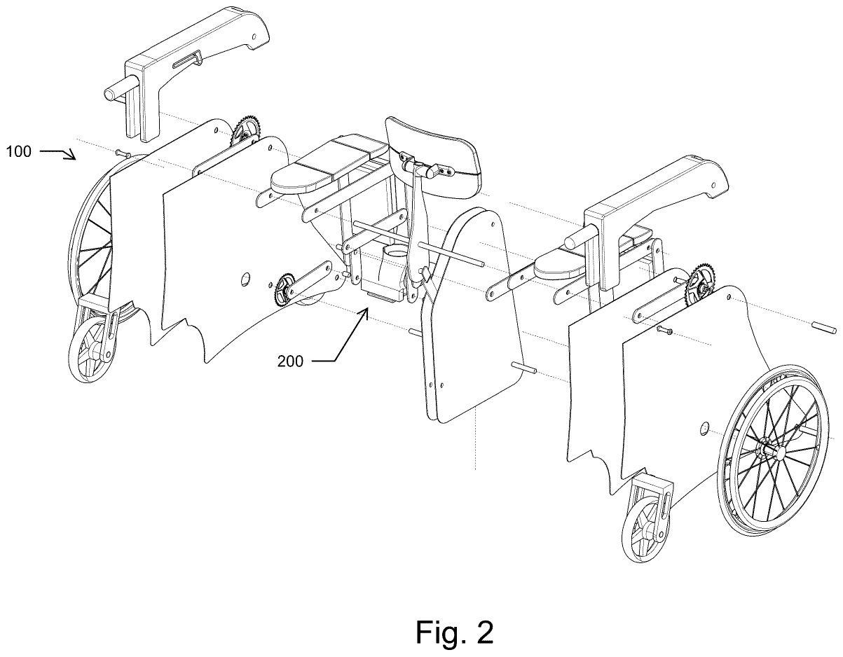

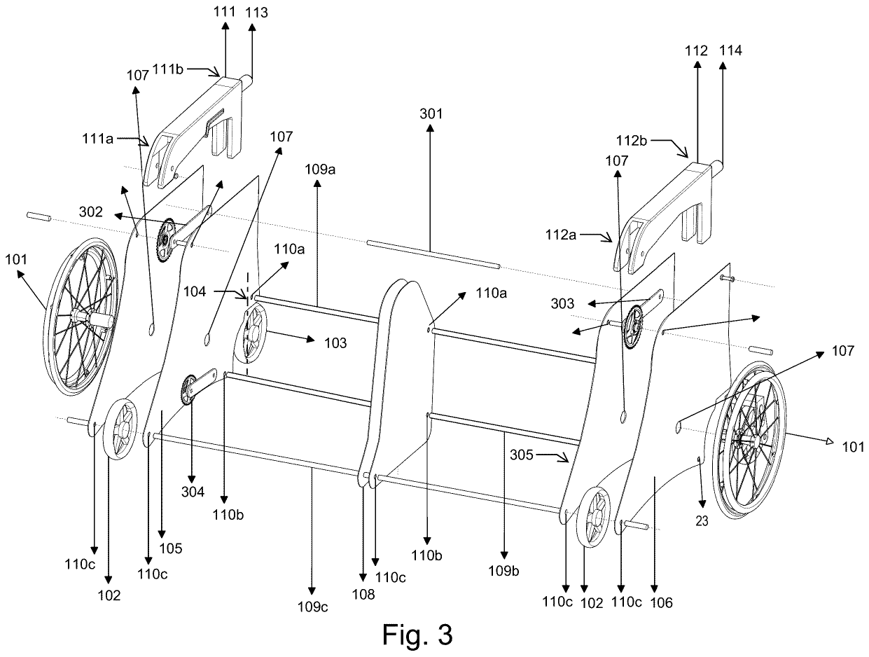

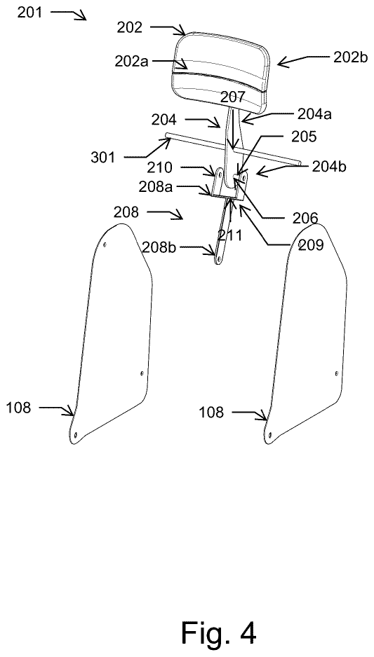

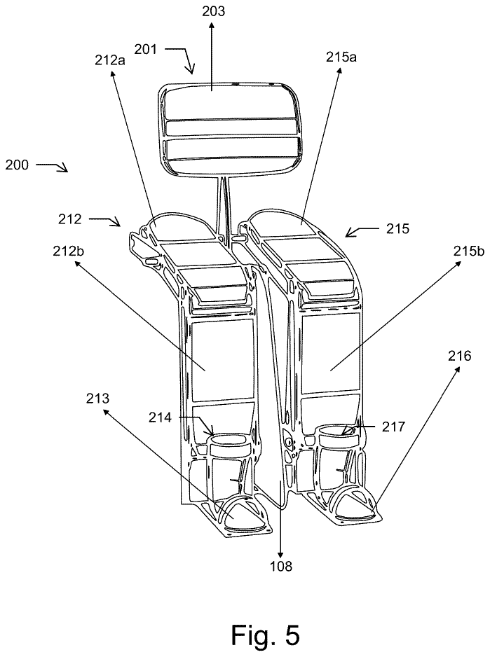

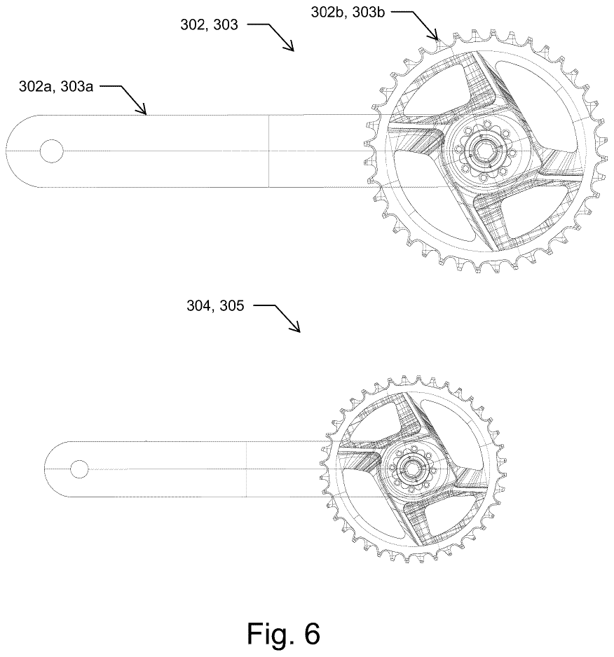

As seen in FIGS. 1-6, the present invention is a wheelchair-integrated exoskeleton assembly for the rehabilitation of individuals with limited mobility of the lower extremities.

The wheelchair-integrated exoskeleton assembly for the rehabilitation of individuals with limited mobility of the lower extremities comprises a wheelchair 100 that has two main larger wheels 101, two smaller front wheels 102, two smaller rotating back wheels 103, a first pair of parallel lateral wheelchair plates 105 on one side and a second pair of parallel lateral wheelchair plates 106 on the opposite side, the first and second pairs of parallel lateral wheelchair plates 105 106 define the lateral contours of the wheelchair. A lightweight ergonomic exoskeleton for the lower extremities 200 that perpendicularly inserts between the first and second pairs of parallel lateral wheelchair plates 105 106, the lightweight ergonomic exoskeleton for the lower extremities 200 has a dorso-lumbar support assembly 201, a first extremity assembly 212 and a second extremity assembly 215 adjacent to the first extremity assembly 212, each of the first and second extremity assemblies 212 215 defines an upper femoral end 212a 215a that connects to a lower distal end 212b 215b with articulation. A transverse rod 301 that articulatingly connects the dorso-lumbar support assembly 201, the upper femoral end 212a 215a of the first and second extremity assemblies 212 215, a first lifting rod assembly 302 that rotationally attaches to the first pair of parallel lateral wheelchair plates 105 and a second lifting rod assembly 303 that rotationally attaches to the second pair of parallel lateral wheelchair plates 106. And, a first pedaling rod assembly 304 that rotationally attaches to the first pair of parallel lateral wheelchair plates 105 and that is articulatingly connected to the lower distal end 212b of the first extremity assembly 212, and a second pedaling rod assembly 305 that rotationally attaches to the second pair of parallel lateral wheelchair plates 106 and that is articulatingly connected to the lower distal end 215b of the second extremity assembly 215. The dorso-lumbar support assembly 201 has a support plate element 202 that defines a front face 202a and a back face 202b, a perpendicular plate element 204 that defines an upper end 204a and a lower end 204b and a fork plate element 208 that defines an upper end 208a and a lower end 208b, the back face 202b of the support plate element 202 rigidly attaches to the upper end 204a of the perpendicular plate element 204, the lower end 204b of the perpendicular plate element 204 hingedly secures to the upper end 208a of the fork plate element 208, and the lower end 208b of the fork plate element 208 rotationally attaches to a pair of parallel lower central wheelchair plates 108 that is positioned sagittally between the first and second pairs of parallel lateral wheelchair plates 105 106. The lightweight ergonomic exoskeleton for the lower extremities 200 positions the user of the wheelchair-integrated exoskeleton assembly at the center of gravity of the wheelchair 100 to make the wheelchair 100 stable under all configurations of the lightweight ergonomic exoskeleton for the lower extremities 200, from its static seated configuration to its moving bipedal configuration.

In an embodiment of the present invention, the lower distal end 212b of the first extremity assembly 212 has a first footrest 213 and the lower distal end 215b of the second extremity assembly 215 has a second footrest 216.

In another embodiment of the present invention, the first and second footrests 213 216 each comprises a set of adjustable fastening straps 214 217.

In another embodiment of the present invention, at least three stability rods 109a 109b 109c brace the first and second pairs of parallel lateral wheelchair plates 105 106 and the pair of parallel lower central wheelchair plates 108 together to increase the stability of the wheelchair-integrated exoskeleton assembly, each of the at least three stability rods 109a 109b 109c secures into a set of apertures 110a 110b 110c in the first and second pairs of parallel lateral wheelchair plates 105 106 and the pair of parallel lower central wheelchair plates 108 that are aligned in a straight line.

In another embodiment of the present invention, one of the at least three stability rods 109a 109b 109c is in line with the two smaller front wheels 102.

In another embodiment of the present invention, one of the two smaller front wheels 102 insert between the first pair of parallel lateral wheelchair plates 105 and the other one of the two smaller front wheels 102 insert between the second pair of parallel lateral wheelchair plates 106.

In another embodiment of the present invention, each of the two smaller rotating back wheels 103 can rotate around a vertical axis 104.

In another embodiment of the present invention, a first armrest 111 is attached horizontally on the first pair of parallel lateral wheelchair plates 105 and a second armrest 112 is attached horizontally on the second pair of parallel lateral wheelchair plates 106, each of the first and second armrests 111 112 defines an anterior end 111a 112a and a posterior end 111b 112b.

In another embodiment of the present invention, a first push handle 113 is rigidly attached to the posterior end 111b of the first armrest 111 and second push handle 114 is rigidly attached to the posterior end 112b of the second armrest 112.

In another embodiment of the present invention, one of the two smaller rotating back wheels 103 insert between the first pair of parallel lateral wheelchair plates 105 and the other one of the two smaller rotating back wheels 103 insert between the second pair of parallel lateral wheelchair plates 106.

In another embodiment of the present invention, each of the first and second pairs of parallel lateral wheelchair plates 105 106 has two wheel axis apertures 107 that are configured to secure one of the two main larger wheels 101.

In another embodiment of the present invention, the upper end 208a of the fork plate element 208 defines a U-shaped plate assembly 209 that has two parallel vertical plate segments 210 rigidly connected with a lower horizontal plate segment 211, and the lower end 204b of the perpendicular plate element 204 inserts between the two parallel vertical plate segments 210 and hingedly secures to them with a pin 205 that inserts through a pin aperture 206 in the lower end 204b of the perpendicular plate element 204.

In another embodiment of the present invention, the support plate element 202 comprises a rectangular concave plate 203, and the transverse rod 301 passes through a rod aperture 207 in the perpendicular plate element 204.

In yet another embodiment of the present invention, each of the first and second lifting road assemblies 302 303 comprises a rod 302a 303a that is articulatingly connected to the transverse rod 301 on one end, and hingedly secured to a dented disk 302b 303b on the other end, the dented disk 302b of the first lifting road assembly 302 inserts between the first pair of parallel lateral wheelchair plates 105 and the dented disk 303b of the second lifting road assembly 303 inserts between the second pair of parallel lateral wheelchair plates 106.

The lifting and pedaling rod assemblies 302 303 304 305 in the above embodiments are connected to gear motors designed for continuous circular motion. The first and second lifting rod assemblies 302 303 would only require about a quarter turn only of such continuous circular motion to fully extend the lightweight ergonomic exoskeleton for the lower extremities 200 to achieve its bipedal configuration.

The general dimensions of the wheelchair 100 in the embodiments described above do not exceed the general dimensions of a standard wheelchair.

An advantage of the present invention is that it enables individuals with reduced mobility to transition from a seated to a standing position while also allowing for movement of their lower extremities.

Another advantage of the present invention is enhanced stability, since the ergonomic lightweight exoskeleton positions the user at the wheelchair's center of gravity and does not shift its own center of gravity with the different configurations it can adopt.

Still another advantage of the present invention is that it can be used outside clinical environments and wherever necessary since it does not exceed the dimensions of a standard wheelchair.

The embodiments of the wheelchair-integrated exoskeleton assembly herein are exemplary and numerous modifications, combinations, variations, and rearrangements can be readily envisioned to achieve an equivalent result, all of which are intended to be embraced within the scope of the appended claims. Further, nothing in the above-provided discussions of the wheelchair-integrated exoskeleton assembly should be construed as limiting the invention to an embodiment or a combination of embodiments. The scope of the invention is defined by the description, drawings, and claims.

What is claimed is:

1. A wheelchair-integrated exoskeleton assembly for the rehabilitation of individuals with limited mobility of the lower extremities, the wheelchair-integrated exoskeleton assembly comprises:
a wheelchair that has two main larger wheels, two smaller front wheels, two smaller rotating back wheels, a first pair of parallel lateral wheelchair plates on one side and a second pair of parallel lateral wheelchair plates on the opposite side, the first and second pairs of parallel lateral wheelchair plates define the lateral contours of the wheelchair;
a lightweight ergonomic exoskeleton for the lower extremities that perpendicularly inserts between the first and second pairs of parallel lateral wheelchair plates, the lightweight ergonomic exoskeleton for the lower extremities has a dorso-lumbar support assembly, a first extremity assembly and a second extremity assembly adjacent to the first extremity assembly, each of the first and second extremity assemblies defines an upper femoral end that connects to a lower distal end with articulation;
a transverse rod that articulatingly connects the dorso-lumbar support assembly, the upper femoral end of the first and second extremity assemblies, a first lifting rod assembly that rotationally attaches to the first pair of parallel lateral wheelchair plates and a second lifting rod assembly that rotationally attaches to the second pair of parallel lateral wheelchair plates; and
a first pedaling rod assembly that rotationally attaches to the first pair of parallel lateral wheelchair plates and that is articulatingly connected to the lower distal end of the first extremity assembly, and a second pedaling rod assembly that rotationally attaches to the second pair of parallel lateral wheelchair plates and that is articulatingly connected to the lower distal end of the second extremity assembly;
wherein the dorso-lumbar support assembly has a support plate element that defines a front face and a back face, a perpendicular plate element that defines an upper end and a lower end and a fork plate element that defines an upper end and a lower end, the back face of the support plate element rigidly attaches to the upper end of the perpendicular plate element, the lower end of the perpendicular plate element hingedly secures to the upper end of the fork plate element, and the lower end of the fork plate element rotationally attaches to a pair of parallel lower central wheelchair plates that is positioned sagittally between the first and second pairs of parallel lateral wheelchair plates; and
wherein the lightweight ergonomic exoskeleton for the lower extremities positions the user of the wheelchair-integrated exoskeleton assembly at the center of gravity of the wheelchair to make the wheelchair stable under all configurations of the lightweight ergonomic exoskeleton for the lower extremities, from its static seated configuration to its moving bipedal configuration.

2. The wheelchair-integrated exoskeleton assembly for the rehabilitation of individuals with limited mobility of the lower extremities of claim 1, wherein the lower distal end of the first extremity assembly has a first footrest and the lower distal end of the second extremity assembly has a second footrest.

3. The wheelchair-integrated exoskeleton assembly for the rehabilitation of individuals with limited mobility of the lower extremities of claim 2, wherein the first and second footrests each comprises a set of adjustable fastening straps.

4. The wheelchair-integrated exoskeleton assembly for the rehabilitation on of individuals with limited mobility of the lower extremities of claim 1, wherein at least three stability rods brace the first and second pairs of parallel lateral wheelchair plates and the pair of parallel lower central wheelchair plates together to increase the stability of the wheelchair-integrated exoskeleton assembly, each of the at least three stability rods secures into a set of apertures in the first and second pairs of parallel lateral wheelchair plates and the pair of parallel lower central wheelchair plates that are aligned in a straight line.

5. The wheelchair-integrated exoskeleton assembly for the rehabilitation of individuals with limited mobility of the lower extremities of claim 4, wherein one of the at least three stability rods is in line with the two smaller front wheels.

6. The wheelchair-integrated exoskeleton assembly for the rehabilitation of individuals with limited mobility of the lower extremities of claim 1, wherein one of the two smaller front wheels insert between the first pair of parallel lateral wheelchair plates and the other one of the two smaller front wheels insert between the second pair of parallel lateral wheelchair plates.

7. The wheelchair-integrated exoskeleton assembly for the rehabilitation of individuals with limited mobility of the lower extremities of claim 6, wherein each of the two smaller rotating back wheels can rotate around a vertical axis.

8. The wheelchair-integrated exoskeleton assembly for the rehabilitation of individuals with limited mobility of the lower extremities of claim 1, wherein a first armrest is attached horizontally on the first pair of parallel lateral wheelchair plates and a second armrest is attached horizontally on the second pair of parallel lateral wheelchair plates, each of the first and second armrests defines an anterior end and a posterior end.

9. The wheelchair-integrated exoskeleton assembly for the rehabilitation of individuals with limited mobility of the lower extremities of claim 8, wherein a first push handle is rigidly attached to the posterior end of the first armrest and second push handle is rigidly attached to the posterior end of the second armrest.

10. The wheelchair-integrated exoskeleton assembly for the rehabilitation of individuals with limited mobility of the lower extremities of claim 1, wherein one of the two smaller rotating back wheels insert between the first pair of parallel lateral wheelchair plates and the other one of the two smaller rotating back wheels insert between the second pair of parallel lateral wheelchair plates.

11. The wheelchair-integrated exoskeleton assembly for the rehabilitation of individuals with limited mobility of the lower extremities of claim 1, wherein each of the first and second pairs of parallel lateral wheelchair plates has two wheel axis apertures that are configured to secure one of the two main larger wheels.

12. The wheelchair-integrated exoskeleton assembly for the rehabilitation of individuals with limited mobility of the lower extremities of claim 1, wherein the upper end of the fork plate element defines a U-shaped plate assembly that has two parallel vertical plate segments rigidly connected with a lower horizontal plate segment, and the lower end of the perpendicular plate element inserts between the two parallel vertical plate segments and hingedly secures to them with a pin that inserts through a pin aperture in the lower end of the perpendicular plate element.

13. The wheelchair-integrated exoskeleton assembly for the rehabilitation of individuals with limited mobility of the lower extremities of claim 1, wherein the support plate element comprises a rectangular concave plate, and the transverse rod passes through a rod aperture in the perpendicular plate element.

14. The wheelchair-integrated exoskeleton assembly for the rehabilitation of individuals with limited mobility of the lower extremities of claim 1, wherein each of the first and second lifting road assemblies comprises a rod that is articulatingly connected to the transverse rod on one end, and hingedly secured to a dented disk on the other end, the dented disk of the first lifting road assembly inserts between the first pair of parallel lateral wheelchair plates and the dented disk of the second lifting road assembly inserts between the second pair of parallel lateral wheelchair plates.
